(19) United States
(12) Patent Application Publication
(10) Pub. No.: US 2015/0290484 A1
(43) Pub. Date: Oct. 15, 2015

(54) METHOD AND APPARATUS OF DECOMPOSING FLUORINATED ORGANIC COMPOUND

(71) Applicant: PERMELEC ELECTRODE LTD., Fujisawa-shi (JP)

(72) Inventors: Hisao Hori, Yokohama-shi (JP); Masaaki Kato, Tamano-shi (JP)

(21) Appl. No.: 14/682,018

(22) Filed: Apr. 8, 2015

(30) Foreign Application Priority Data
Apr. 14, 2014 (JP) 2014-083193

(51) Int. Cl. A62D 3/17; C25B 3/00

(52) U.S. Cl. CPC A62D 3/17; C25B 3/00; A62D 2101/22

(57) ABSTRACT

A method of decomposing a fluorinated organic compound involves irradiating a target fluorinated organic compound with light in the presence of electrolyzed sulfuric acid. In detail, the inventive method involves adding electrolyzed sulfuric acid prepared by electrolysis of an aqueous sulfuric acid solution at an anode to a solution containing the target fluorinated organic compound and irradiating the solution with light to decompose the fluorinated organic compound into fluoride ions and carbon dioxide. The method can decompose fluorinated organic compounds at reduced decomposition energy, without high-temperature incineration that has been conventionally required. An apparatus for decomposing a fluorinated organic compound is also provided that is utilizable in practicing the method.

### TECHNICAL FIELD

The present invention relates to a method and apparatus of decomposing a fluorinated organic compound.

### BACKGROUND ART

Fluorinated organic compounds have carbon-fluorine bonds that are very stable. Due to the carbon-fluorine bonds, fluorinated organic compounds have special chemical properties and thus are important compounds used in a wide variety of applications, such as solvents, electric materials, coating materials, surfactants, and mold release agents. Among the fluorinated organic compounds, carboxylic acids having fluorinated alkyl groups, such as trifluoroacetic acid, have high acidity, and are used in a variety of fields. For example, they may be used as catalysts in synthetic organic chemistry.

While such fluorinated organic compounds are useful in various fields as described above, their chemical stability causes several problems. For example, incineration of waste fluorinated organic compounds requires an adequately high incineration temperature, which undesirably increases energy required for the incineration and also damages the incinerator to reduce its lifetime. Fluorinated organic compounds released into the environment are not readily decomposed due to their chemical stability and undesirably are accumulated in the environment.

In view of such a background, several measures have been proposed for chemical decomposition of such fluorinated organic compounds at their sources. For example, PTL 1 proposes photodecomposition of fluorinated organic compounds in the presence of oxygen with tungsten heteropoly acid as a photocatalyst.

### CITATION LIST

### Patent Literature

PTL 1 Japanese Patent Application Laid-Open Publication No. 2003-40805

### SUMMARY OF INVENTION

### Technical Problem

Unfortunately, the photodecomposition using a photocatalyst described in PTL 1 causes problems such as high catalyst costs for industrial-scale decomposition of fluorinated organic compounds. No practical method has been developed that can readily cleave the stable carbon-fluorine bonds of fluorinated organic compounds to decompose them.

The present invention has been accomplished under such a circumference, and an object of the invention is to provide a novel and efficient method of decomposing a fluorinated organic compound and an apparatus for decomposing a fluorinated organic compound utilizable in practicing the method.

### Solution To Problem

The inventors have found that a fluorinated organic compound is decomposed and mineralized by photoirradiation of a solution to be treated containing the fluorinated organic compound and electrolyzed sulfuric acid that has been prepared by electrolytic oxidation of sulfuric acid, and have accomplished the present invention. Electrolyzed sulfuric acid contains peroxydisulfate ions. Also known is decomposition of fluorinated organic compounds by irradiation of a solution to be treated containing peroxydisulfates with light (see, for example, Japanese Patent Application Laid-Open Publication No. 2005-225785). The inventors, however, have found that electrolyzed sulfuric acid unexpectedly decomposes fluorinated organic compounds at a higher rate than a solution containing peroxydisulfates at a concentration equivalent to the peroxydisulfate ion concentration of the electrolyzed sulfuric acid. The present invention has been accomplished based on such findings, and provides the following method.

The present invention provides a method of decomposing a fluorinated organic compound comprising irradiating a target fluorinated organic compound with light in the presence of electrolyzed sulfuric acid.

The fluorinated organic compound is preferably fluorinated carboxylic acid represented by the following formula:

R¹C(O)OH,

wherein R¹ is an alkyl group containing at least one fluorine atom.

The method preferably comprises adding sulfuric acid and/or electrolyzed sulfuric acid to a solution to be treated containing the fluorinated organic compound and applying a voltage across an anode and a cathode placed in the solution to oxidize the sulfuric acid contained in the solution into electrolyzed sulfuric acid at the anode.

The voltage is preferably applied continuously across the anode and the cathode until the concentration of the fluorinated organic compound in the solution is lower than a predetermined concentration while the sulfuric acid produced during decomposition of the fluorinated organic compound is reused as electrolyzed sulfuric acid.

The fluorinated organic compound is preferably perfluorocarboxylic acid.

The perfluorocarboxylic acid is preferably trifluoroacetic acid.

The present invention also provides an apparatus for decomposing a fluorinated organic compound, comprising a reaction vessel to contain a solution to be treated containing sulfuric acid and the fluorinated organic compound, an anode and a cathode that are disposed so as to be placed in the solution if the reaction vessel contains the solution, the anode and the cathode being connectable to a power source, and a photoirradiation unit for irradiating the solution with light, wherein decomposition of the fluorinated organic compound involves applying a voltage across the anode and the cathode after the solution is placed in the reaction vessel, thereby oxidizing the sulfuric acid into electrolyzed sulfuric acid at the anode, and irradiating the solution with light in the presence of the electrolyzed sulfuric acid.

### Advantageous Effects of Invention

The present invention provides a novel and efficient method of decomposing a fluorinated organic compound and an apparatus of decomposing a fluorinated organic compound utilizable in practicing the method.

### BRIEF DESCRIPTION OF DRAWINGS

FIG. 1 is a schematic view illustrating a first embodiment of the apparatus of decomposing a fluorinated organic compound according to the present invention.

FIG. 2 is a schematic view illustrating a second embodiment of the apparatus of decomposing a fluorinated organic compound according to the present invention.

FIG. 3 is a plot of concentrations of trifluoroacetic acid (TFA), carbon dioxide (CO₂), and fluoride ion (F⁻) versus photoirradiation time when a reaction solution containing trifluoroacetic acid is irradiated with light in the presence of electrolyzed sulfuric acid (Example 1) and shows variations in the concentrations of these chemical species.

FIG. 4 is a plot of concentrations of trifluoroacetic acid (TFA), carbon dioxide (CO₂), and fluoride ion (F⁻) versus photoirradiation time when a reaction solution containing trifluoroacetic acid is irradiated with light in the presence of potassium peroxydisulfate (Comparative Example 1) and shows variations in the concentrations of these chemical species.

### DESCRIPTION OF EMBODIMENTS

Embodiments of the method of decomposing a fluorinated organic compound of the present invention will now be described. The present invention provides a method of decomposing a fluorinated organic compound comprising irradiating a target fluorinated organic compound with light in the presence of electrolyzed sulfuric acid. The first embodiment of the method of decomposing a fluorinated organic compound of the present invention will now be described.

Fluorinated organic compounds are molecules having stable carbon-fluorine bonds; hence, a traditional decomposition process thereof requires treatment at a high temperature. In contrast, the method of the present invention can decompose such compounds into fluoride ions, carbon dioxide, and other chemical species without high-temperature treatment, with reduced energy consumption. In the method of the present invention, the target fluorinated organic compound includes compounds having one or more fluorine atoms. Examples of such compounds include fluorinated carboxylic acids, fluorinated sulfonic acids, and fluorinated alcohols. Among these examples, preferred are fluorinated carboxylic acids represented by Formula (1):

R¹C(O)OH (1)

In Formula (1), R¹ is an alkyl group containing at least one fluorine atom. In addition to the fluorine atom(s), such an alkyl group may contain one or more hydrogen atoms and/or halogen atoms, such as a chlorine atom or chlorine atoms. Examples for better understanding of such alkyl groups include —CClF₂, —CCl₂F, —CHF₂, —CH₂F, and —CBrF₂. The alkyl group may have any number of carbon atoms, and generally has one to ten carbon atoms.

A preferred form of the fluorinated carboxylic acid is perfluorocarboxylic acid that has an alkyl group consisting only of carbon and fluorine atoms. Perfluorocarboxylic acids have a perfluorinated alkyl group as R¹ in Formula (1), and are normally represented by the formula R_{f}C(O)OH. Examples of such perfluorocarboxylic acids include trifluoroacetic acid, pentafluoropropionic acid, and perfluoro-n-octanoic acid. Among these examples, trifluoroacetic acid is preferred.

Electrolyzed sulfuric acid is produced during electrolysis of an aqueous sulfuric acid solution at an anode exposed to an oxygen atmosphere, and includes peroxydisulfuric acid, peroxymonosulfuric acid, and hydrogen peroxide that are produced by oxidation of sulfuric acid. These materials can be produced by a relatively simple process involving electrolysis of an aqueous sulfuric acid solution, and already have uses in industrial fields, such as resist removal and cleaning of semiconductors in their manufacturing process.

For preparation of electrolyzed sulfuric acid, an aqueous sulfuric acid solution is placed in an electrolytic reaction vessel for electrolysis, an anode and a cathode are disposed in the aqueous sulfuric acid solution so as to face each other across an ion-permeable separation membrane, and then a current is applied across the anode and the cathode. Then water is reduced to produce hydrogen at the cathode while sulfuric acid and water are oxidized to produce electrolyzed sulfuric acid and oxygen at the anode. The aqueous sulfuric acid solution to be electrolyzed is separated into anolyte and catholyte by the separation membrane, which prevents the electrolyzed sulfuric acid produced at the anode from moving toward the cathode to be reduced again to sulfuric acid. After the electrolysis, the solution at the anode containing the electrolyzed sulfuric acid is collected to be used as electrolyzed sulfuric acid in the method of the present invention. Alternatively, the solution at the anode containing the electrolyzed sulfuric acid may be continuously collected during the electrolysis, while fresh aqueous sulfuric acid solution is being supplied. The separation membrane prevents mixing of the anolyte containing the electrolyzed sulfuric acid and the catholyte not containing it, which prevents the electrolyzed sulfuric acid from being reduced at the cathode, as described above, and keeps a high concentration of electrolyzed sulfuric acid. The separation membrane is also helpful for safety as it separates the cathode gas (hydrogen) from the air and the anode gas (oxygen). In view of these effects, such a separation membrane is preferably present in the production of the electrolyzed sulfuric acid; however, the separation membrane is not essential for production of the electrolyzed sulfuric acid.

The anode and cathode may be composed of any electrode material that is resistant to corrosion in sulfuric acid or oxidation at the anode. Examples of such an electrode include a platinum electrode and an electrically conductive diamond electrode (boron-doped diamond electrode). Among these examples, preferred is an electrically conductive diamond electrode from the viewpoint of enhanced production efficiency of the electrolyzed sulfuric acid because it exhibits high oxidation ability during the electrolysis. The current density between the anode and the cathode may be appropriately selected depending on various conditions, and is within a range of approximately 10 A/dm² to 200 A/dm² on the basis of the electrode area, for example. Preferably provided is a mechanism for separately circulating the solution at the anode (anolyte) and the solution at the cathode (catholyte) across the reaction vessel and an external vessel, which allows electrolysis of a large amount of aqueous sulfuric acid solution in a small electrolytic vessel.

The aqueous sulfuric acid solution used in the electrolysis may have any concentration, and is within a range of typically 1 to 12 mol/L, preferably 2 to 9 mol/L, more preferably 3 to 7 mol/L. The aqueous sulfuric acid solution may be prepared by diluting commercially available concentrated sulfuric acid (98%, 18 mol/L) with pure water to a desired concentration. While the anolyte is electrolyzed sulfuric acid, the catholyte may be any solution that causes the reduction reaction of water at the cathode. In other words, the catholyte maybe any liquid that allows electric current to flow, that is, contains ions. If an aqueous sulfuric acid solution is used as a catholyte, the anolyte and the catholyte may contain different concentrations of sulfuric acid.

For the sake of better understanding, conditions for the preparation of the electrolyzed sulfuric acid are now described. The conditions below are applicable to a case where aqueous sulfuric acid solution is electrolyzed in an electrolytic reaction vessel that includes an anode and a cathode of electrically conductive diamond electrode (boron-doped diamond electrode) with an electrolytic area of 1.000 dm² and is provided with a separation membrane, while the anolyte and the catholyte are separately circulated between the reaction vessel and an external vessel.
Vessel current: 100 A
Current density: 100 A/dm²
Sulfuric acid concentration: 7.12 mol/L (in both anolyte and catholyte)
Amount of anolyte: 300 mL
Amount of catholyte: 300 mL
Liquid temperature: 28° C.
Anolyte flow rate: 1 L/min
Catholyte flow rate: 1 L/min
Separation membrane: POREFLON (registered trademark) manufactured by SUMITOMO ELECTRIC FINE POLYMER, INC.

As described above, the electrolyzed sulfuric acid includes peroxydisulfuric acid or peroxydisulfate ion, peroxymonosulfuric acid or peroxymonosulfate ion, and hydrogen peroxide. The target fluorinated organic compound is added to an electrolyzed sulfuric acid solution containing such chemical species, and the resulting solution is irradiated with light, thereby decomposing the fluorinated organic compound.

Peroxydisulfuric acid included in the electrolyzed sulfuric acid is also referred to as persulfuric acid, and is represented by the chemical formula H₂S₂O₈. The peroxydisulfate ion from peroxydisulfuric acid is also referred to as persulfate ion, and is represented by the chemical formula S₂O₈²⁻. The only difference between peroxydisulfuric acid and peroxydisulfate ion is if the chemical species from peroxydisulfuric acid are in ionic form or not, and they have the same effect on the decomposition of fluorinated organic compounds during the photoirradiation. The following description will focuses on the behavior of peroxydisulfate ions, which is useful for explanation of the behavior of peroxydisulfuric acid, because peroxidisulfuric acid differs from the peroxydisulfate ion only in that the chemical species therefrom are not in ionic form.

During photoirradiation, O—O bonds in the peroxydisulfate ions are cleaved to produce sulfate ion radicals, represented by the chemical formula SO₄⁻., that decompose fluorinated organic compounds. The electrolyzed sulfuric acid may contain any amount of peroxydisulfate ion or peroxydisulfuric acid, preferably 0.5 part by mass or more with respect to 1 part by mass of the fluorinated organic compound, more preferably 3 parts by mass or more with respect to 1 part by mass of the fluorinated organic compound. The content of peroxydisulfate ions in the electrolyzed sulfuric acid can be determined by attenuated total reflection infrared (ATR-IR) spectroscopy, for example.

The light for the photoirradiation has a wavelength of preferably 320 nm or less, more preferably 240 nm to 260 nm. The intensity of the light is preferably several milliwatts per square meter or more. Examples of the light source used for the photoirradiation include mercury xenon lamps, bactericidal lamps (low-pressure mercury lamps), high-pressure mercury lamps, and metal halide lamps. The photoirradiation time preferably ranges from several hours to one day. The solution temperature during the photoirradiation (that is, reaction temperature) ranges preferably from 0 to 90° C., more preferably from 10 to 30° C.

Although the mechanism of the decomposition reaction of fluorinated organic compounds is not clear in the method of the present invention, it is presumed that the decomposition is initiated by a reaction between sulfate ion radicals produced from the peroxydisulfate ions formed during photoirradiation and fluorinated organic compounds. A presumed reaction mechanism of decomposition of perfluorocarboxylic acid will now be explained.

Since increased sulfate ion and carbon dioxide concentrations are observed in the reaction system as the reaction proceeds, the sulfate ion radicals produced from the peroxydisulfate ions during the photoirradiation probably oxidize perfluorocarboxylic acid, as shown in the following reaction formula:

R_{f}C(O)O⁻+SO₄⁻.→.R_{f}+CO₂+SO₄²⁻,

where R_{f} represents a perfluoroalkyl group.

Once perfluorocarboxylic acid is decomposed to produce R_{f} radicals as shown in the reaction formula, the unstable R_{f} radicals readily would cause oxidation reactions in the solution to cleave the carbon-fluorine bonds, and are decomposed to fluoride ions and other chemical species. Examples of chemical species involved in such an oxidation reaction include oxygen dissolved in the solution and hydrogen peroxide contained in the electrolyzed sulfuric acid. The reaction mechanism of the decomposition of trifluoromethyl radicals (.CF₃; produced as a result of the decomposition of trifluoroacetic acid in the reaction described above) to fluoride ions and carbon dioxide is represented as follows:

.CF₃+O₂→CF₃O₂.

CF₃O₂.+HO₂.→CF₃O₂H+O₂

CF₃O₂+H O₂.→CF₃O.+.OH

CF₃O.+HO₂.→CF₃OH+O₂

CF₃OH→COF₂+HF

COF₂+H₂O→CO₂+2HF

The series of reactions indicate that perfluorocarboxylic acid contained in the solution is decomposed into mineral components, i.e., carbon dioxide, fluoride ions, and other chemical species, as a result of reaction(s) with sulfate ion radicals produced from the electrolyzed sulfuric acid that has been formed in the solution during the photoirradiation.

According to the reaction mechanism explained above, the sulfate ion radicals produced from peroxydisulfate ions are involved in the first reaction in the series of decomposition reactions, and peroxydisulfuric acid contained in the electrolyzed sulfuric acid plays an important role in the decomposition reactions of the fluorinated organic compound. The inventors prepared an aqueous solution containing peroxydisulfate ions at the same concentration as in the electrolyzed sulfuric acid from potassium peroxydisulfate (K₂S₂O₈) and purified water, for example, and compared decomposition reactions of a fluorinated organic compound by photoirradiation in the presence of such a solution and the electrolyzed sulfuric acid, respectively, for the decomposition rate of the fluorinated organic compound. Unexpectedly, the electrolyzed sulfuric acid decomposed the fluorinated organic compound at a higher decomposition rate, regardless of the same concentration of peroxydisulfate ions between the solution prepared above and the electrolyzed sulfuric acid. Although the reason for such a result is not clear, a possible factor may be synergistic effects caused by peroxydisulfate ions and other chemical species, such as peroxymonosulfate ions, contained in the electrolyzed sulfuric acid. The present invention has been accomplished based on such findings, and the special feature thereof is the use of electrolyzed sulfuric acid in photodecomposition of fluorinated organic compounds. The present invention may also be practiced using a peroxydisulfate such as potassium peroxydisulfate in combination with the electrolyzed sulfuric acid.

A more specific example of the first embodiment of the present invention will be now described.

An aqueous solution containing a fluorinated organic compound and electrolyzed sulfuric acid are filled in a stainless steel reaction vessel placed in a water bath for temperature control. A liquid for temperature control is circulated in the vessel to maintain the temperature of the reaction solution in the reaction vessel at a temperature within the range of 10 to 30° C. (more specifically, 25° C.). The upper portion of the reaction vessel has a sapphire window through which the reaction solution is irradiated with light emitted from a light source. The light source has a mercury xenon lamp which emits ultraviolet to visible light (220 nm to 460 nm). The light source may have any luminous body that can emit ultraviolet light with a wavelength of 320 nm or less. The inside of the reaction system is preferably filled with argon gas, but may be filled with other gas such as air or nitrogen gas.

The light source is then turned on to emit light to irradiate the reaction solution. After the photoirradiation is continued for several hours to one day, the decomposition of fluorinated organic compound is confirmed.

The second embodiment of the method of decomposing fluorinated organic compounds of the present invention will be now described. The description of this embodiment focuses on differences from the first embodiment, without duplicated description similar to the description in the first embodiment.

In the first embodiment, the fluorinated organic compound is decomposed by photoirradiation in the presence of previously prepared electrolyzed sulfuric acid. In the second embodiment, sulfuric acid and/or electrolyzed sulfuric acid is added to the solution to be treated containing the fluorinated organic compound, the fluorinated organic compound is decomposed by photoirradiation of the solution while the sulfuric acid is being produced, and then the solution is electrolyzed to prepare electrolyzed sulfuric acid. The sulfuric acid includes compounds that can provide sulfate ions, such as sulfates.

As described above, peroxydisulfate ions contained in the electrolyzed sulfuric acid are converted into sulfate ion radicals (SO₄⁻.) by photoirradiation. The sulfate ion radicals are involved in decomposition of the fluorinated organic compound contained in the solution and then are converted into sulfate ions (SO₄²⁻) that do not have the decomposition ability. Thus, in the first embodiment, once the electrolyzed sulfuric acid initially added is used up in the decomposition reaction of the fluorinated organic compound, the decomposition cannot be further continued. In this embodiment, the decomposition is performed while the solution is being electrolyzed, and the sulfate ions produced as a result of decomposition of the fluorinated organic compound are oxidized again at the anode to be reused as electrolyzed sulfuric acid, which allows continuous decomposition of the target fluorinated organic compound that is continuously added to the reaction vessel.

According to this embodiment, in addition to the elements of the first embodiment as described above, the method further involves adding sulfuric acid and/or electrolyzed sulfuric acid to a solution to be treated containing a target fluorinated organic compound, and applying a voltage across an anode and a cathode placed in the solution, the sulfuric acid contained in the solution is thereby oxidized into electrolyzed sulfuric acid at the anode. In the first embodiment, the electrolyzed sulfuric acid is added to the solution. In the second embodiment, sulfuric acid is added in place of electrolyzed sulfuric acid because this embodiment is provided with an anode and a cathode for electrolyzing the solution. The sulfuric acid added to the solution and sulfuric acid produced from the electrolyzed sulfuric acid as the decomposition reaction proceeds are oxidized again into electrolyzed sulfuric acid at the anode. Electrolyzed sulfuric acid may also be added initially to the solution as in the first embodiment.

Materials for the anode and the cathode, and conditions such as current density at the time of applying a voltage across the anode and the cathode are the same as in the production of electrolyzed sulfuric acid described in the first embodiment. Light for irradiating the solution is also the same as in the first embodiment. Similar to the first embodiment, an ion-permeable separation membrane is disposed between the anode and the cathode, which prevents flow between the anolyte and the catholyte while ensuring the current flow for electrolysis. In this case, since the electrolyzed sulfuric acid is produced at the anode, the target fluorinated organic compound is placed in the anolyte.

The fluorinated organic compound may be decomposed in the electrolytic reaction vessel provided with the anode and the cathode while the anolyte in the electrolytic reaction vessel is being irradiated with light or while the anolyte in the electrolytic reaction vessel is being circulated through a decomposition vessel with a light source for photoirradiation and the electrolytic reaction vessel by a transfer means, such as pump. Electrolysis and the decomposition of the fluorinated organic compound are performed in a single vessel in the former case, while the electrolysis and the decomposition of the fluorinated organic compound are performed in separate vessels in the latter case. The method according to this embodiment may be practiced in either of these methods.

According to the method for decomposition of the present invention, persistent fluorinated organic compounds having chemically stable carbon-fluorine bonds can be decomposed by photoirradiation in the presence of electrolyzed sulfuric acid. The inventive method provides for decomposition of persistent fluorinated organic compounds with reduced decomposition energy, without high-temperature incineration.

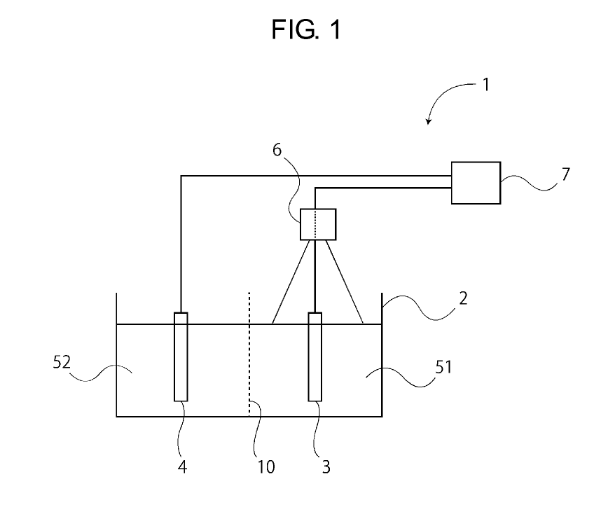

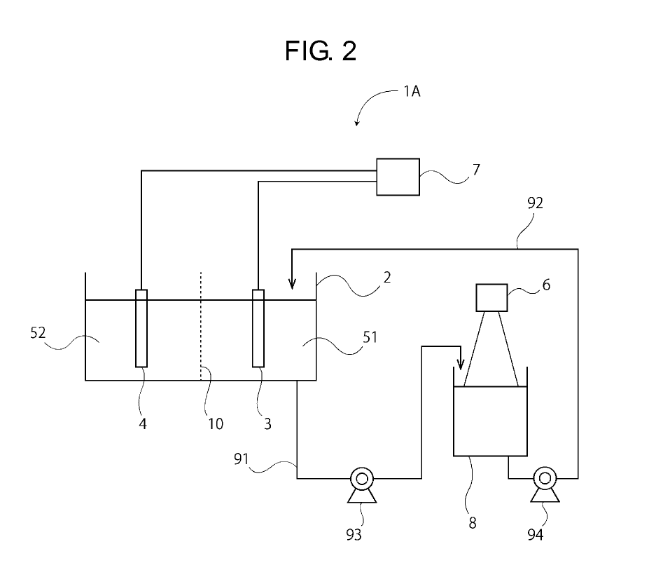

The present invention also provides an apparatus for decomposing fluorinated organic compounds suitable for practicing the method described above (hereinafter, also referred to as simply “decomposition apparatus”). Such a decomposition apparatus is based on the principle of reactions described above, and is used for decomposition of fluorinated organic compounds. The decomposition apparatus includes a vessel to contain a solution to be treated which contains sulfuric acid and a target fluorinated organic compound, and an anode and a cathode that are disposed so as to be placed in the solution if the vessel contains the solution, the anode and the cathode being connectable to a power source, and a photoirradiation unit for irradiating the solution with light. The decomposition of the target fluorinated organic compound involves applying a voltage across the anode and the cathode after the solution is placed in the vessel, thereby oxidizing the sulfuric acid into electrolyzed sulfuric acid at the anode, and irradiating the solution with light in the presence of the electrolyzed sulfuric acid. Embodiments of the decomposition apparatus of the present invention will now be described with reference to the accompanying drawings. FIG. 1 is a schematic view illustrating the first embodiment of the decomposition apparatus of the present invention. FIG. 2 is a schematic view of the second embodiment of the present invention. As used herein, the term “sulfuric acid” refers not only to sulfuric acid but also to sulfates that can supply sulfate ions. In the description below, conditions of the electrolysis, the mechanism of the decomposition reaction, and materials for individual elements are the same as those described above, and are not described now. The description below focuses on the mechanism of the decomposition apparatus.

The first embodiment of the decomposition apparatus of the present invention (decomposition apparatus 1) will now be described with reference to FIG. 1. The decomposition apparatus 1 has an electrolytic reaction vessel 2, an anode 3, a cathode 4, a power source 7 to apply a voltage across the anode 3 and the cathode 4, and a photoirradiation unit (light source) 6 for irradiating a solution contained in the electrolytic reaction vessel 2 with light.

In the electrolytic reaction vessel 2, the anode 3 and the cathode 4 are disposed parallel with each other separated by a separation membrane 10. The separation membrane 10, the anode 3, and the cathode 4 are described above. The separation membrane 10 partitions the inside of the electrolytic reaction vessel 2 into two segments, so that an anolyte 51 is placed to immerse the anode 3, while a catholyte 52 is placed to immerse the cathode 4. The anolyte 51 contains sulfuric acid, which is electrolytically oxidized into electrolyzed sulfuric acid as described above. The anolyte 51 is a solution to be treated containing the target fluorinated organic compound. The catholyte 52 may be any electrolyte through which electric current flows for electrolysis, and may be an electrolyte containing sulfuric acid, like the anolyte 51, or an electrolyte containing other ion component(s).

The anode 3 and the cathode 4 are electrically connected to positive and negative electrodes (not shown) of the power source 7, respectively. The power source 7 applies a voltage for electrolysis across the anode 3 and the cathode 4. The electrolysis oxidizes the sulfuric acid in the anolyte 51 into electrolyzed sulfuric acid.

The light source 6 is a unit for irradiating a solution, that is, the anolyte 51. As described above, the light source 6 emits light with a wavelength of 320 nm or less, and this light causes sulfate ion radicals to be formed from the electrolyzed sulfuric acid (particularly peroxydisulfuric acid) contained in the anolyte 51. As described above, such sulfate ion radicals decompose the fluorinated organic compound.

The second embodiment of the decomposition apparatus of the present invention (decomposition apparatus 1A) will now be described with reference to FIG. 2. In the description of the second embodiment, the same elements as in the first embodiment are identified with the same reference numerals without redundant description.

The decomposition apparatus 1A differs from the decomposition apparatus 1 in that the decomposition apparatus 1A has two separate vessels, that is, the electrolytic reaction vessel 2 for electrolysis and the decomposition vessel 8 involving decomposition of the fluorinated organic compound by irradiation with light from the light source 6. Thus, the light source 6 is disposed not in the electrolytic reaction vessel 2 but in the decomposition vessel 8. The anolyte 51 after electrolysis in the electrolytic reaction vessel 2 is transferred to the decomposition vessel 8 via an outflow line 91 having a pump 93, irradiated with light from the light source 6, and then returned to the anode 3 in the electrolytic reaction vessel 2 via an inflow line 92 having a pump 94. The electrolyzed sulfuric acid produced from sulfuric acid by electrolysis is converted into sulfate radicals and then converted into sulfuric acid in the decomposition vessel 8, and sulfuric acid is returned to the anode 3 in the electrolytic reaction vessel 2 to be electrolyzed there. Although the decomposition apparatus 1A of this embodiment is different from the decomposition apparatus 1 of the first embodiment in that the electrolyzed sulfuric acid or sulfuric acid is circulated across the electrolytic reaction vessel 2 and the decomposition vessel 8, the embodiments have the same essence that electrolyzed sulfuric acid produced by electrolysis is converted into sulfate radicals by photoirradiation to decompose fluorinated organic compounds.

### EXAMPLES

The present invention will now be described in more detail by way of Examples. The present invention however should not be limited to these Examples.

In an electrolytic reaction vessel (electrolytic cell) that has an anode and a cathode composed of electrically conductive diamond electrodes (boron-doped diamond electrodes) with an electrolytic area of 1 dm² and an ion exchange separation membrane (GORE SELECT (registered trademark) manufactured by W. L. Gore & Associates (Japan)) that is a cation-exchange membrane, aqueous sulfuric acid solution was electrolyzed under conditions of a current density of 50 A/dm² and a liquid temperature of 30° C., while the anolyte and the catholyte were separately circulated through their external circulating pathways and the anolyte was collected. Electrolyzed sulfuric acid was thereby prepared. The raw materials, anolyte and catholyte for electrolysis were each 300 mL of an aqueous sulfuric acid solution (7.12 mol/L). After the electrolysis, the sulfuric acid concentration was 3.7 mol/L and the total oxidizer concentration was 1.1 mol/L in the anolyte. This anolyte was diluted 20 times with pure water to prepare electrolyzed sulfuric acid solution with a total oxidizer concentration of 53 mmol/L and a sulfuric acid concentration of 1.5 wt %. The total oxidizer concentration was determined by measuring the oxidizer concentration with potassium iodide and converting the oxidizer concentration into peroxydisulfic acid concentration.

The resulting electrolyzed sulfuric acid was measured for concentrations of S₂O₈²⁻ and H₂O₂ by attenuated total reflection infrared (ATR-IR) spectroscopy and determination with Ti-porphyrin reagent. The electrolyzed sulfuric acid contained 31 mM of S₂O₈²⁻ and 0.58 mM of H₂O₂. The electrolyzed sulfuric acid was used in the decomposition experiment of trifluoroacetic acid as described below. The determination with Ti-porphyrin reagent is one of the methods for absorptiometric determination of hydrogen peroxide. In such a method, change in the absorbance at 432 nm when hydrogen peroxide coordinated to titanium, the central metal of Ti-porphyrin was determined. Since the change in the absorbance (at 432 nm) per 1M of hydrogen peroxide is 190,000 M⁻¹cm⁻¹, the hydrogen peroxide concentration can be calculated by dividing the measured value of the change in the absorbance by the value above. The Ti-porphyrin reagent used in this determination is available from TOKYO CHEMICAL INDUSTRY, CO., LTD., for example.

### Example 1

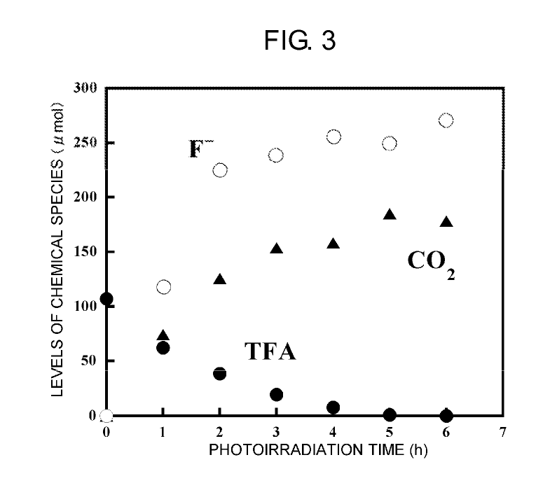

Trifluoroacetic acid (107.1 μmol, 5.35 mM) was added to 20 mL of the electrolyzed sulfuric acid described above, and the solution was placed in the reaction vessel. The inside of the reaction vessel was pressurized with oxygen gas to 0.5 MPa, and then ultraviolet and visible light (220 to 460 nm) was emitted from a mercury xenon lamp while the solution was stirred. The liquid temperature in the reaction vessel was 25° C. The reaction solution was analyzed hourly after the initiation of photoirradiation by ion chromatography and ion exclusion chromatography to determine the concentrations of trifluoroacetic acid (TFA) and fluoride ions (F⁻), and the gaseous phase in the reaction vessel was analyzed by gas chromatography to determine the concentration of carbon dioxide (CO₂). The results were plotted in the graph shown in FIG. 3, where the horizontal axis represents the photoirradiation time and the vertical axis represents the concentrations of the individual chemical species.

FIG. 3 demonstrates that the concentration of trifluoroacetic acid decreased in accordance with the pseudo-first-order reaction rate equation (k=0.567 h⁻¹) during the photoirradiation in the presence of the electrolyzed sulfuric acid, and reached an undetectable level six hours after the initiation of photoirradiation. In contrast, the concentrations of carbon dioxide and fluoride ions increased with the photoirradiaton time. These results demonstrate that trifluoroacetic acid was decomposed and mineralized into carbon dioxide and fluoride ions. The yields of fluoride ions and carbon dioxide at six hours after the initiation of photoirradiation were 85.1% and 84.1%, respectively.

### Example 2

The variation in the concentration of trifluoroacetic acid was observed as in Example 1, except that the light was monochromatic light with a wavelength of 254 nm for determining the quantum yield in the decomposition of trifluoroacetic acid by photoirradiation in the presence of electrolyzed sulfuric acid. The decrease rate of trifluoroacetic acid was 8.89×10⁻⁸ mol/min. The intensity of light absorbed in the reaction solution was 4.30 einstein/min, and thus the quantum yield in the decomposition of trifluoroacetic acid was 0.21 (=8.89×10⁻⁸/4.30×10⁻⁷).

### Comparative Example 1

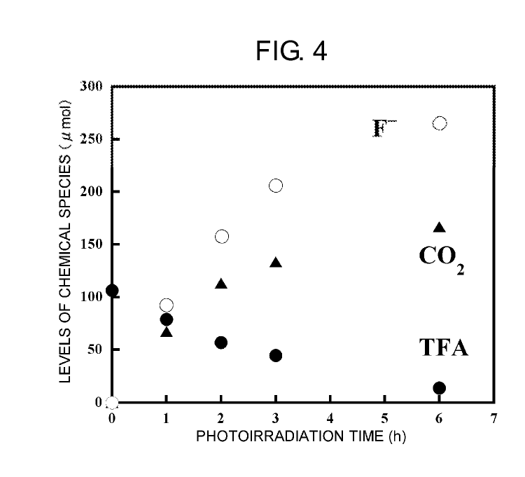

Photoirradiation was performed as in Example 1, except that the electrolyzed sulfuric acid was replaced with an aqueous solution of potassium peroxydisulfate (K₂S₂O₈) containing the same concentration of peroxydisulfate ions (S₂O₈²⁻) as that of the electrolyzed sulfuric acid. Variations over time in the concentrations of trifluoroacetic acid, fluoride ions and carbon dioxide were determined. The results were plotted in the graph shown in FIG. 4, where the horizontal axis represents the photoirradiation time and the vertical axis represents the concentrations of the individual chemical species.

FIG. 4 demonstrates that the concentration of trifluoroacetic acid also decreases in accordance with the pseudo-first-order reaction rate equation in the photoirradiation in the presence of the aqueous potassium peroxydisulfate solution, but the rate constant (k=0.292 h⁻¹) is lower than that in Example 1 (i.e., photoirradiation in the presence of the electrolyzed sulfuric acid).

### Comparative Example 2

Photoirradiation was performed as in Example 1, except that the electrolyzed sulfuric acid was replaced with an aqueous hydrogen peroxide solution with the same concentration of hydrogen peroxide (H₂O₂) as that of the electrolyzed sulfuric acid. Decomposition of trifluoroacetic acid was not confirmed.

These results suggest that peroxymonosulfate ions (HSO₅⁻) contained in the electrolyzed sulfuric acid contribute to an increase in the higher decomposition rate in the presence of the sulfuric acid than that in the presence of the aqueous potassium peroxydisulfate solution. Such results demonstrate that the present invention provides a novel and efficient method of decomposing fluorinated organic compounds.

1. A method of decomposing a fluorinated organic compound, comprising irradiating a target fluorinated organic compound with light in the presence of electrolyzed sulfuric acid.

2. The method of decomposing a fluorinated organic compound according to claim 1, wherein the fluorinated organic compound is fluorinated carboxylic acid represented by the following formula:
R¹C(O)OH,
wherein R¹ is an alkyl group containing at least one fluorine atom.

3. The method of decomposing a fluorinated organic compound according to claim 1, comprising adding at least one of sulfuric acid or electrolyzed sulfuric acid to a solution to be treated containing the fluorinated organic compound, and applying a voltage across an anode and a cathode immersed in the solution to be treated, to oxidize the sulfuric acid contained in the solution to be treated into electrolyzed sulfuric acid at the anode.

4. The method of decomposing a fluorinated organic compound according to claim 1, wherein the fluorinated organic compound is perfluorocarboxylic acid.

5. The method of decomposing a fluorinated organic compound according to claim 2, wherein the fluorinated organic compound is perfluorocarboxylic acid.

6. The method of decomposing a fluorinated organic compound according to claim 3, wherein the fluorinated organic compound is perfluorocarboxylic acid.

7. The method of decomposing a fluorinated organic compound according to claim 4, wherein the perfluorocarboxylic acid is trifluoroacetic acid.

8. The method of decomposing a fluorinated organic compound according to claim 5, wherein the perfluorocarboxylic acid is trifluoroacetic acid.

9. The method of decomposing a fluorinated organic compound according to claim 6, wherein the perfluorocarboxylic acid is trifluoroacetic acid.

10. An apparatus for decomposing a fluorinated organic compound, comprising:
a vessel to contain a solution to be treated which contains sulfuric acid and a target fluorinated organic compound;
an anode and a cathode that are disposed so as to be immersed in the solution to be treated when the vessel contains the solution to be treated, the anode and the cathode being connectable to a power source; and
a photoirradiation unit for irradiating the solution to be treated with light,
wherein decomposition of the fluorinated organic compound involves applying a voltage across the anode and the cathode when the solution to be treated is present in the vessel, thereby oxidizing the sulfuric acid into electrolyzed sulfuric acid at the anode, and irradiating the solution to be treated with light in the presence of the electrolyzed sulfuric acid.
